(19) United States
(12) Patent Application Publication
(10) Pub. No.: US 2022/0195234 A1
(43) Pub. Date: Jun. 23, 2022

(54) ONE-COMPONENT VAPOR PERMEABLE AIR BARRIER COALESCABLE AT LOW TEMPERATURE

(71) Applicant: Tremco Incorporated, Beachwood, OH (US)

(72) Inventors: Mason Averill, Copley, OH (US); Pamela Hernandez, Medina, OH (US)

(21) Appl. No.: 17/559,381

(22) Filed: Dec. 22, 2021

Related U.S. Application Data
(60) Provisional application No. 63/128,947, filed on Dec. 22, 2020.

(51) Int. Cl. C09D 133/08; C09D 7/63; B05D 5/00; B05D 7/24

(52) U.S. Cl. CPC C09D 133/08; C09D 7/63; B05D 2502/00; B05D 7/24; B05D 5/00

(57) ABSTRACT

A coating composition for use as a water vapor permeable air barrier. The coating composition comprises an acrylic latex, 1-10% by weight of glycol ether, and 0.25-5% by weight of humectant. The coating composition, when measured at 77° F. (25° C.) using a Brookfield HB viscometer equipped with Spindle 3 at 2.5 RPM, has a viscosity ranging from 5000 to 500000 cPs. When coalesced, the coating composition forms a water vapor permeable air barrier having a water vapor permeance greater than 1 Perm at 35 mil film thickness when measured at 77° F. (25° C.) and 50% RH, according to ASTM E96/E96M-16, Method B.

### RELATED APPLICATIONS

This application claims priority to and any benefit of U.S. Provisional Patent Application No. 63/128,947, filed Dec. 22, 2021, the content of which is incorporated herein by reference in its entirety.

### FIELD

This disclosure relates to building envelope liquid air barrier coating compositions, the air barrier coatings formed therefrom, substrates coated with such air barrier coatings, and methods for forming an air barrier from the coating compositions.

### BACKGROUND

Building envelope barrier systems may include air barriers for stopping the unintended passage of air, water, and other elements into and out of a building enclosure. For some applications, air barriers with good water vapor permeability is preferred. Some air barriers can be formed by applying a liquid coating composition onto a substrate. The use of liquid-applied coating compositions is known to present difficulties at low ambient temperatures, where the composition may freeze and/or not properly form.

### SUMMARY

The present disclosure provides liquid-applied air barrier coating compositions as well as air barrier coatings, substrates coated with the air barrier coatings, and methods of forming an air barrier on a substrate formed from such coating compositions. The coating composition comprises an acrylic latex, 1-10% by weight of glycol ether, and 0.25-5% by weight of humectant. The coating composition, when measured at 77° F. (25° C.) using a Brookfield HB viscometer equipped with Spindle 3 at 2.5 RPM, has a viscosity ranging from 5000 to 500000 cPs. When coalesced, the coating composition forms a water vapor permeable air barrier having a water vapor permeance greater than 1 Perm at 35 mil film thickness when measured at 77° F. (25° C.) and 50% RH, according to ASTM E96/E96M-16, Method B.

### DETAILED DESCRIPTION

An acrylic latex-based water vapor permeable air barrier coating composition is described in the present disclosure. The coating composition includes glycol ether and humectant. In accordance with the present disclosure, the inclusion of both the glycol ether and the humectant has surprising effects on the properties of the coating formed by the coating composition. Not only does the glycol ether and humectant improve the working range of temperatures over which the coating compositions may be applied, these two components provide unexpectedly improved elongation and water vapor permeability of the resulting coating.

At low ambient temperatures, coating compositions may not form satisfactory coatings due to freezing. For example, some water-based coatings freeze at an ambient temperature below 32° F. (0° C.). After application of such coating compositions to a substrate at a low ambient temperature where freezing occurs, water does not sufficiently evaporate from the applied coating. This may result in cracks in the formed coating, rendering the coating unsuitable for an air barrier. Moreover, low temperatures may cause the properties of the coating composition to change, for example, viscosity and rate of skin formation, which may also negatively affect the ease of use and the properties of the formed coating. Therefore, coating compositions suitable for use at low ambient temperatures, including for example 40° F., 32° F., and even 20° F., are preferred. Such coating compositions should form crack-free coatings suitable for air barrier, and the formed coatings should preferably present desirable properties, such as good elongation and good water vapor permeability.

In accordance with the present disclosure, freezing point depressant such as glycol ether can be added to an acrylic latex-based coating composition such that freezing occurs at lower temperatures. As result, the coating composition may form a crack-free coating at ambient temperatures at or below the freezing point of water. However, as disclosed below (see Examples 1 and 2), addition of glycol ether negatively affects both the water vapor permeability and elongation of the resulting coating.

To address this issue, in accordance with the present disclosure, a humectant is added to the coating composition and surprisingly offsets the negative effects from the freezing point depressants. As disclosed below (see Example 3), addition of glycerin as humectant was found to unexpectedly restore the water vapor permeability to substantially the same water vapor permeability prior to the addition of the freezing point depressant. Moreover, in accordance with the present disclosure, addition of glycerin as humectant was also found to unexpectedly improve the elongation of the formed coating. As disclosed below (see Example 3), the addition of humectant not only offsets the decrease in elongation caused by the freezing point depressant, but also further results in an elongation even greater than the elongation prior to the addition of the freezing point depressant. As such, in accordance with the present disclosure, the coating composition comprising both glycol ether and humectant unexpectedly allows application at low temperatures while maintaining good water vapor permeability of the formed coating, and also unexpectedly improves the elongation of the formed coating.

In accordance with the present disclosure, the air barrier coating composition comprises an acrylic latex, 1-10% by weight of glycol ether, and 0.25-5% by weight of humectant. The coating composition, when measured at 77° F. (25° C.) using a Brookfield HB viscometer equipped with Spindle 3 at 2.5 RPM, has a viscosity ranging from 5000 to 500000 cPs. When coalesced, the coating composition forms a water vapor permeable air barrier having a water vapor permeance greater than 1 Perm at 35 mil film thickness when measured at 77° F. (25° C.) and 50% RH, according to ASTM E96/E96M-16, Method B.

As discussed above, the coating composition includes an acrylic latex. Suitable acrylic latices that may be used include, but are not limited to, aqueous dispersions or emulsions having an acrylic polymer dispersed or emulsified in an aqueous continuous (liquid) phase. The aqueous phase may comprise water only, or water and other liquids dissolved in water. The acrylic polymer includes an acrylic homopolymer or a copolymers of acrylate and non-acrylate monomers. The acrylic polymer has a low Tg, including for example, has a Tg below 20° C., including a Tg below 0° C., and including a Tg between −50° C. to 20° C. Examples of suitable commercially available acrylic latices include, but are not limited to, RHOPLEX 2620 Emulsion Polymer available from Dow Chemical Company (Midland, Michigan), ACRONAL 4511 available from BASF Corporation (Florham Park, New Jersey), and PLIOTEC EL25 available from Synthomer (Atlanta, Ga.).

The acrylic polymer used in the latex can be described by the monomers used to form the polymer. Examples of suitable monomers for the acrylic polymer include, but are not limited to, (meth)acrylate esters, for example, alkyl esters including C 1 to C10 alkyl esters, aryl esters including phenyl esters, hydroxyalkyl esters including C1 to C10 hydroxyalkyl esters, and polyalkyleneoxy esters including polyethyleneoxy esters; glycidyl(meth)acrylate; (meth)acrylic acids and their salts; (meth)acrylic amides, N-alkyl (meth)acrylamide, and N,N-dialkyl (meth)acrylamide; aminoalkyl (meth)acrylate; (meth)acrylonitrile; and sulphonated acrylic monomers. The monomers may also be multifunctional, for example, alkyldiol di(meth)acrylates including ethylene glycol diacrylate. The acrylic polymer may be a copolymer (including block, random, and alternate copolymers) of one or more suitable monomers. Moreover, the acrylic polymer may be a copolymer of one or more suitable monomers and one or more other monomers, for example, alkenes including ethene and propene, and vinyl monomers including styrene.

The acrylic latex disclosed herein may be present in the coating composition in an amount of, for example, 20-80% by weight, including 30-70% by weight, 40-70% by weight, and 60-70% by weight. The weight percentage of the acrylic polymer in the acrylic latex (i.e., % solids) is not particularly limited, as long as the coating composition can be applied to the surface of a substrate and coalesce to form a film. For example, the content of the acrylic polymer in the acrylic latex may be 20-90% solids by weight, including 30-85%, 40-80%, 50-75%, 55-70%, and 60-65% solids by weight.

As discussed above, the coating composition includes a glycol ether. The glycol ether disclosed herein, includes, but is not limited to, any alkyl ether of a glycol. Examples of the glycol include, but are not limited to, ethylene glycol, propylene glycol, butylene glycol, diethylene glycol, and dipropylene glycol. Examples of the alkyl group include, but are not limited to, C1 to C10 alkyls including methyl, ethyl, propyl, isopropyl, butyl, isobutyl, sec-butyl, and tert-butyl. The glycol ether may also be a dialkyl ether with same or different alkyl groups.

Specific examples of suitable glycol ethers include monomethyl ether of dipropylene glycol, propylene glycol n-butyl ether, ethylene glycol phenyl ether, dipropylene glycol n-butyl ether, ethylene glycol monomethyl ether, and diethylene glycol monomethyl ether. In some aspects of the present disclosure, the glycol ether has a boiling point above that of the water and/or any other liquids, solvents, or azeotropes that may be in the coating composition, such that the glycol ether remains in the coating composition until the liquids present in the coating composition have completely or substantially evaporated off. The coating composition may include one glycol ether, or two or more different glycol ethers. In some aspects of the present disclosure, the glycol ether acts as freezing point depressant that lowers the freezing point of the coating composition. The glycol ether may also act as a freeze-thaw stabilizer that improves the freeze-thaw stability of the coating composition, i.e., an agent that stabilizes the dispersion or emulsion in the frozen state and during freezing and thawing.

The glycol ether disclosed herein is present in the coating composition in an amount of, for example, 1-10% by weight, and including 3-10% by weight, 4-10% by weight, and 5-10% by weight.

As discussed above, the coating composition includes a humectant. The humectant disclosed herein is not particularly limited, as long as it is compatible with the acrylic latex. For example, the humectant may be miscible, soluble, or emulsifiable in the liquid phase of the acrylic latex. Examples of suitable humectants include, but are not limited to, polyhydric alcohols and polyols, for example, glycerin, sorbitol, and pentaerythritol. The humectant disclosed herein may comprise one or more compounds acting as humectant. In some aspects of the present disclosure, the humectant may also act as freezing point depressant which lowers the freezing point of the coating composition. For example, glycerin may act as both humectant and freezing point depressant. In some aspects of the present disclosure, the humectant is preferably glycerin.

The humectant disclosed herein is present in the coating composition in an amount of, for example, 0.25-5% by weight, and including 0.75-4% by weight, 1-3% by weight, and 1-2% by weight.

In accordance with the present disclosure, the coating composition may further comprise one or more additives including surfactants, freeze-thaw additives, silane adhesion promoters, plasticizers, thickeners, fillers, tints/pigments/dyes, crosslinkers such as zinc oxide, and biocides.

The surfactant additive disclosed herein may comprise one or more ethoxylate surfactants, sulfate surfactants, or combination thereof. In some aspects of the present disclosure, the surfactant may comprise an alkylphenol ethoxylate having C2-C14 in the alkyl group, sodium alkyl sulfate having C2-C14 in the alkyl group, or a combination of alkylphenol ethoxylate and sodium alkyl sulfate. The surfactant disclosed herein may be present in the coating composition in an amount of, for example, 0-2% by weight, and including 0-1.5% by weight, 0-1% by weight, and 0.1-0.6% by weight.

The freeze-thaw additives disclosed herein may comprise one or more compounds that improve the freeze-thaw stability of the coating composition (in addition to the glycol ether, where the glycol ether may also act as a freeze-thaw stabilizer). Examples of the freeze-thaw additives include, but are not limited to, glycols, including ethylene glycol, propylene glycol, butylene glycol, diethylene glycol, and dipropylene glycol; polyalkylene glycols, including polyethylene glycol and polypropylene glycol; alkoxylated alcohols; diols; and polyols.

The freeze-thaw additives disclosed herein may be present in the coating composition in an amount of, for example, 0-5% by weight, and including 0-4% by weight, 0.5-3% by weight, and 1-2% by weight.

The silane adhesion promoter additive disclosed herein may comprise one or more silane compounds that improve the adhesion of the air barrier formed by the coating composition to a substrate. Examples of the silane compounds include, but are not limited to, alkylsilanes, alkoxysilanes, acetoxysilanes, vinylsilanes, chlorosilanes, aminosilanes, ureidosilanes, epoxy-functional silanes, acryloxysilanes, mercaptosilanes, oximinosilanes, and fluorosilanes. In some aspects of the present disclosure, the silane adhesion promoter comprises 3-glycidoxypropyltrimethoxysilane.

The silane adhesion promoter disclosed herein may be present in the coating composition in an amount of, for example, 0-2.2% by weight and including 0-2% by weight, 0-1.5% by weight, 0-1% by weight, and 0.2-0.5% by weight.

The plasticizer additive disclosed herein may comprise additives that improve the flexibility or elongation of the air barrier formed by the coating composition. Examples of suitable plasticizers include, but are not limited to, mineral oil such as white mineral oil, phthalates, alkyl sulfonyl esters of phenol, trimellitates, and benzoates. The plasticizers disclosed herein may be present in the coating composition in an amount of, for example, 0-20% by weight and including 1-18% by weight, 2-16% by weight, 3-14% by weight, 4-12% by weight, and 5-10% by weight.

The thickener additive disclosed herein may comprise additives that affects the viscosity of the coating composition. Examples of the thickeners include, but are not limited to, ammonium hydroxide, HASE (hydrophobically modified alkali-soluble emulsion), cellulose thickeners including HEC (hydroxyethyl cellulose), PVC (polyvinyl chloride) plastisols, or combinations thereof. The thickeners disclosed herein may be present in the coating composition in an amount that results in a viscosity within a predetermined range, for example, 5000 to 500000 cPs (as measured at 77° F. (25° C.) by a Brookfield HB viscometer equipped with Spindle 3 at 2.5 RPM). In some aspects of the present disclosure, the thickeners are present in the coating composition in an amount of, for example, 0-10% by weight, including 0-8% by weight, 0-6% by weight, 0-4% by weight, 0-2% by weight, and 0.5-1% by weight. In coating compositions comprising ammonium hydroxide, the ammonium hydroxide may act as both thickener and pH adjuster. In accordance with the present disclosure, the coating composition may further comprise pH adjusters that affect the pH of the coating composition, such that the pH is within a predetermined range, for example, 6-11 and including 8-10.

The filler additive disclosed herein may comprise any known material suitable for acrylic latex based compositions, for example, kaolin clay, mica, heavy spar, talc, sand, quartz flour, titanium dioxide, silica, fumed silica, fly ash, calcium carbonate, wollastonite, graphene, carbon black, or combinations thereof. The fillers disclosed herein may be present in the coating composition in an amount of, for example, 0-40% by weight, including 0-20% by weight, 2-40% by weight, 2-20% by weight, 2-10% by weight, and 2-5% by weight.

Any suitable tint, pigment, or for use in acrylic-latex based compositions, such as titanium dioxide, may be used. The tint or pigment additive disclosed herein may be present in the coating composition in an amount of, for example, 0-5% by weight and including 0-4% by weight, 0.2-3% by weight, and 0.5-2% by weight.

The biocide additive disclosed herein may comprise one or more chemical or biological substances that affect the activity of organisms, for example, pesticides, herbicides, fungicides, and insecticides. In some aspects of the present disclosure, the biocides comprise fungicides such as iodopropynyl butylcarbamate, methyl 2-benzimidazolecarbamate, or combinations thereof. The biocides disclosed herein may be present in the coating composition in an amount of 0-1% by weight, including 0.1-0.5% by weight.

The coating composition disclosed herein may further comprise added liquid components, for example water or nonaqueous solvents, as the balance of the composition.

The coating composition disclosed herein has a viscosity ranging from, for example, 5,000 to 500,000 cPs and including 6,000 to 500,000 cPs, 8,000 to 500,000 cPs, 10,000 to 500,000 cPs, 15,000 to 500,000 cPs, 20,000 to 500,000 cPs, 30,000 to 500,000 cPs, 50,000 to 500,000 cPs, 100,000 to 500,000 cPs, 150,000 to 500,000 cPs, 180,000 to 500,000 cPs, 230,000 to 500,000 cPs, 50,000 to 450,000 cPs, 100,000 to 400,000 cPs, 150,000 to 350,000 cPs, 200,000 to 300,000 cPs, and 230,000 to 250,000 cPs, when measured at 77° F. (25° C.) using a Brookfield HB viscometer equipped with Spindle 3 at 2.5 RPM. The viscosity can be adjusted with additives such as thickeners, depending on the intended method of application such as spraying, rolling, or troweling.

The coating composition disclosed herein preferably has a low VOC (volatile organic compound) content, less water and exempt solvents. Unless otherwise indicated, the VOC' s are determined by the U.S. EPA Test Method 24 (Oct. 7, 2020). In accordance with the present disclosure, the coating composition may have a VOC content of 200 g/L or less, including 180 g/L or less, 160 g/L or less, 150 g/L or less, 100 g/L or less, 75 g/L or less, 50 g/L or less, 30 g/L or less, 15 g/L or less, 10 g/L or less, and no VOCs.

In accordance with the present disclosure, the coating composition can be liquid-applied to the surface of a substrate by, for example, spraying, rolling, or troweling. In some aspects of the present disclosure, the substrate is an exterior sheathing panel of a building. After application to the substrate, the liquids present in the coating composition evaporate, including, for example, the liquid phase of the acrylic latex, the solvents that may be present in the other components, and solvents that may be added to the coating composition. As the liquids evaporate, the coating composition coalesces to form an air barrier on the substrate.

The coating composition disclosed herein is preferably coalescable at low ambient temperatures. In accordance with the present disclosure, the coating composition are coalescable at low ambient temperatures, for example, 40° F. (˜4.44° C.), 32° F. (0° C.), or 20° F. (˜−6.67° C.). In accordance with the present disclosure, the coating composition may be coalescable at an ambient temperature of 20° F. to 100° F. (˜37.78° C.), including 20° F. to 80° F. (˜26.67° C.), 20° F. to 60° F. (˜15.56° C.), 20° F. to 40° F., and 20° F. to 32° F.

The coating composition disclosed herein have a skin formation time of 2-12 hours, including 2-10 hours and 2-8 hours, and a full coalesce time of 12-48 hours, including 14-36 hours, 16-24 hours, and 16-20 hours, at 20° F. (˜−6.67° C.).

The air barrier disclosed herein have a thickness of 15-50 mils, including 20-40 mils, and 25-35 dry mils. The air barrier disclosed herein preferably has good permeability for water vapor. In accordance with the present disclosure, the air barrier has a water vapor permeance of 1 to 30 Perm, including 5 to 25 Perm, 10 to 20 Perm, and 10 to 12 Perm at 35 mil film thickness when measured at 77° F. (23° C.) and 50% RH, according to ASTM E96/E96M-16, Method B.

The air barrier disclosed herein have a tensile strength of 50 to 200 psi, including 75 to 175 psi, 100 to 150 psi, and 110 to 130 psi, as tested by ASTM D412-16 (designation number D412-16). The air barrier disclosed herein has an elongation (as defined in ASTM D412-16, where elongation=(1-1₀)/1₀×100% with 1₀ being the initial length and 1 being the length at failure) ranging from 300 to 1500%, including 500 to 1300%, 700 to 1200%, and 900 to 1000%.

In accordance with the present disclosure, a method of forming an air barrier on a substrate comprises applying the coating composition as described above to a surface of the substrate. The substrate disclosed herein may be an exterior sheathing panel of a building. After application to the substrate, the coating composition coalesces to form the air barrier on the substrate.

Suitable substrates that the air barrier coating compositions of the present disclosure may be applied to include, wood, engineered wood, metal, concrete, CMU (concrete masonry unit), other waterproofing coatings and sealants, gypsum, and plastics.

In accordance with the present disclosure, a substrate is coated with an air barrier formed by coalescing the coating composition as described above on the surface of the substrate. The substrate disclosed herein may be an exterior sheathing panel of a building.

In accordance with the present disclosure, an air barrier coating is formed by coalescing a coating composition as described above on the surface of a substrate. The substrate disclosed herein may be an exterior sheathing panel of a building.

### EXAMPLES

In accordance with the present disclosure, samples of coating compositions were prepared. The ingredients of the samples are shown in Table 1 in weight percent.

TABLE 1

| Component | Example 1 | Example 2 | Example 3 |
|---|---|---|---|
| acrylic polymer emulsion (62% in | 65.13 | 65.13 | 65.13 |
| water) | | | |
| sodium alkyl sulfate | 0.11 | 0.11 | 0.11 |
| alkylphenol ethoxylate | 0.13 | 0.13 | 0.13 |
| propylene glycol | 1.41 | 1.41 | 1.41 |
| white mineral oil | 6.08 | 6.08 | 6.08 |
| Silane adhesion promoter | 0.36 | 0.36 | 0.36 |
| ammonium hydroxide | 0.85 | 0.85 | 0.85 |
| water | 20.63 | 11.63 | 11.41 |
| fumed silica | 2.94 | 2.94 | 2.94 |
| zinc oxide | 0.23 | 0.23 | 0.23 |
| Tints, dyes, and/or colorants | 0.98 | 0.98 | 0.98 |
| biocide | 0.19 | 0.19 | 0.19 |
| HASE (hydrophobically modified | 0.96 | 0.96 | 0.96 |
| alkali-soluble emulsion) | | | |
| monomethyl ether of dipropylene | — | 9.0 | 7.72 |
| glycol | | | |
| glycerin | — | — | 1.5 |
| Total weight percent | 100 | 100 | 100 |
| Tensile strength (psi) | 120 | 150 | 120 |
| Elongation | 900% | 600% | 950% |
| Permeance (Perm) | 11.7 | 7.8 | 10.8 |

### Example 1

The ingredients of Example 1 were made into a coating composition through the following steps: (1) an acrylic latex (acrylic polymer emulsion) was added to a mixer; (2) a surfactant (sodium alkyl sulfate), premixed with water, was added; (3) a second surfactant (alkylphenol ethoxylate) was added, then mixed for 5 minutes; (4) a freeze-thaw additive (propylene glycol), a plasticizer (mineral oil), and a silane adhesion promoter were added, and mixed for 10 minutes; (5) a thickener (ammonium hydroxide) was slowly added, and mixed for 15 minutes; (6) half of the total water was added, and mixed for ten minutes; (7) a filler (fumed silica) was slowly added in several small additions; (8) tints, pigments, and/or dyes and zinc oxide were added, and mixed for 10 minutes; (9) the remaining water was added and mixed for 15 minutes; (10) a biocide and a second thickener (HASE) were added, and mixed for 20 minutes.

The coating composition according to Example 1 did not coalesce into a defect-free film at 20° F. (˜−6.67° C.). Instead, the coating composition according to Example 1 froze at 20° F., leaving significant cracks in the membrane. As such, the coating formed by Example 1 at 20° F. was unsuitable as an air barrier coating.

The tensile properties were measured according to ASTM D412-16. The coating formed by Example 1 was found to have a tensile strength of 120 psi and an elongation of 900%. The water vapor permeance was measured according to ASTM E96/E96M-16, Method B. The coating formed by Example 1 was found to have a permeance of 11.7 Perm at 35 mil film thickness. With 11.7 Perm of permeance, the coating formed by Example 1 is classified as water vapor permeable (i.e., permeance greater than 10 Perm).

### Example 2

The ingredients of Example 2 were made into a coating composition through the same steps as in Example 1, with an additional step for the glycol ether (monomethyl ether of dipropylene glycol) component. The glycol ether was added as the last step, followed by mixing for 15 minutes.

The coating composition according to Example 2 coalesced into a defect-free film at 20° F. (˜−6.67° C.). The glycol ether (monomethyl ether of dipropylene glycol) was found to act as a freezing point depressant, preventing the freezing of the coating composition at 20° F. As result, water was allowed to evaporate from the applied coating composition without freezing. As such, the coating formed by Example 2 at 20° F. was suitable as an air barrier coating. The tensile properties and water vapor permeance were respectively measured according to ASTM D412-16 and ASTM E96/E96M-16, Method B. The coating formed by Example 2 was found to have a tensile strength of 150 psi, an elongation of 600%, and a permeance of 7.8 Perm at 35 mil film thickness. As such, compared to the coating formed by Example 1, the coating formed by Example 2 had a greater stiffness with decreased elongation and a smaller permeance. With 7.8 Perm of permeance, the coating formed by Example 2 is not classified as water vapor permeable, but rather semi-permeable (i.e., permeance from 1 Perm and 10 Perm).

Therefore, with the addition of a glycol ether (monomethyl ether of dipropylene glycol) to the composition of Example 1, Example 2 formed a coating suitable as an air barrier coating when coalesced at 20° F. However, the formed coating had decreased elongation and did not have a good water vapor permeability.

### Example 3

The ingredients of Example 3 were made into a coating composition through the same steps as in Example 1, with an additional step for the glycol ether (monomethyl ether of dipropylene glycol) and the humectant (glycerin) components. The glycol ether and the humectant were added as the last step, followed by mixing for 15 minutes.

The coating composition according to Example 3 coalesced into a defect-free film at 20° F. (˜−6.67° C.). The combination of glycol ether (monomethyl ether of dipropylene glycol) and the glycerin humectant was found to act as a freezing point depressant, preventing the freezing of the coating composition at 20° F. As result, water was allowed to evaporate from the applied coating composition without freezing. As such, the coating formed by Example 3 at 20° F. was suitable as an air barrier coating. The tensile properties and water vapor permeance were respectively measured according to ASTM D412-16 and ASTM E96/E96M-16, Method B. The coating formed by Example 2 was found to have a tensile strength of 120 psi, an elongation of 950%, and a permeance of 10.8 Perm at 35 mil film thickness. As such, compared to the coating formed by Example 2, the coating formed by Example 3 had an improved elongation, which was even greater than the elongation of the coating formed by Example 1 (900%). Compared to the coating formed by Example 2, the coating formed by Example 3 also had an improved permeance. With 10.8 Perm of permeance, the coating formed by Example 3 is classified as water vapor permeable.

Therefore, with the addition of a humectant (glycerin) to the composition of Example 2, Example 3 formed a coating suitable as a vapor permeable air barrier coating when coalesced at 20° F. The humectant was found to offset the negative effect of the glycol ether (monomethyl ether of dipropylene glycol) on elongation and water vapor permeability which was observed from the comparison of Example 1 and Example 2. From Example 3, an improvement in elongation beyond the elongation of Example 1 was observed.

While the present disclosure describes exemplary aspects of coating compositions, articles, and methods in detail, the present disclosure is not intended to be limited to the disclosed aspects. Also, certain elements of exemplary aspects disclosed herein are not limited to any exemplary aspects, but instead apply to all aspects of the present disclosure.

The terminology as set forth herein is for description of the aspects of this disclosure only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, the phrase “at least one of A, B, and C” should be interpreted as “only A or only B or only C or any combinations thereof.”

The coating compositions, articles, and associate methods of making the coating composition or the article of the present disclosure can comprise, consist of, or consist essentially of the essential elements of the disclosure as described herein, as well as any additional or optional element described herein or which is otherwise useful in coating applications.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

1. A coating composition, which, when coalesced, forms a water vapor permeable air barrier, comprising:
an acrylic latex;
1-10% by weight of glycol ether; and
0.25-5% by weight of humectant,
wherein the coating composition, when measured at 77° F. (25° C.) using a Brookfield HB viscometer equipped with Spindle 3 at 2.5 RPM, has a viscosity ranging from 5000 to 500000 cPs,
wherein an air barrier formed by the coating composition has a water vapor permeance greater than 1 Perm at 35 mil film thickness when measured at 77° F. (25° C.) and 50% RH, according to ASTM E96/E96M-16, Method B.

2. The coating composition according to claim 1, wherein the coating composition coalesces at an ambient temperature of 40° F. (˜4.44° C.) or higher.

3. The coating composition according to claim 1, wherein the coating composition coalesces at an ambient temperature of 20° F. (˜−6.67° C.) or higher.

4. The coating composition according to claim 1, wherein the coating composition has a VOC content of 100 g/L or less.

5. The coating composition according to claim 1, wherein the acrylic latex comprises an acrylic polymer having a Tg of −50° C. to 20° C.

6. The coating composition according to claim 1, wherein the glycol ether comprises at least one of monomethyl ether of dipropylene glycol, propylene glycol n-butyl ether, ethylene glycol phenyl ether, dipropylene glycol n-butyl ether, ethylene glycol monomethyl ether, diethylene glycol monomethyl ether, or combinations thereof.

7. The coating composition according to claim 1, wherein the humectant comprises at least one of glycerin, sorbitol, pentaerythritol, other polyhydric alcohol or polyol, or combinations thereof.

8. The coating composition according to claim 1, further comprising at least one of a surfactant, a freeze-thaw additive, a silane adhesion promoter, a plasticizer, a thickener, a filler, a tint, a biocide, or combinations thereof.

9. The coating composition according to claim 8, wherein the surfactant comprises at least one of an ethoxylate surfactant, a sulfate surfactant, or a combination thereof.

10. The coating composition according to claim 8, wherein the coating composition comprises 1-2% by weight of freeze-thaw additive.

11. The coating composition according to claim 8, wherein the coating composition comprises 5-10% by weight of plasticizer.

12. The coating composition according to claim 8, wherein the coating composition comprises 2-40% by weight of filler.

13. The coating composition according to claim 12, wherein the filler comprises at least one of kaolin clay, mica, heavy spar, talc, sand, quartz flour, titanium dioxide, silica, fumed silica, fly ash, calcium carbonate, wollastonite, graphene, carbon black, or combinations thereof.

14. The coating composition according to claim 1, wherein the coating composition has a skin formation time of 2-12 hours and a full coalesce time of 16-24 hours at 20° F. (˜−6.67° C.).

15. The coating composition according to claim 1, wherein the water vapor permeable air barrier has tensile strength ranging from 50 to 200 psi as tested by ASTM D412-16 and elongation ranging from 300 to 1500%.

16. A method of forming an air barrier on a substrate, comprising:
applying a coating composition to a surface of the substrate, wherein the coating composition coalesces to form a water vapor permeable air barrier on the substrate,
the coating composition comprising:
an acrylic latex;
1-10% by weight of a glycol ether; and
0.25-5% by weight of humectant,
wherein the coating composition, when measured at 77° F. (25° C.) using a Brookfield HB viscometer equipped with Spindle 3 at 2.5 RPM, has a viscosity ranging from 5000 to 500000 cPs,
wherein the air barrier has a water vapor permeance greater than 1 Perm at 35 mil film thickness when measured at 77° F. (23° C.) and 50% RH, according to ASTM E96/E96M-16, Method B.

17. The method of forming an air barrier on a substrate according to claim 16, wherein the coating composition coalesces at an ambient temperature of 20° F. (˜−6.67° C.) or higher.

18. A substrate coated with an air barrier, the air barrier being formed by coalescing a coating composition on the surface of the substrate,
wherein the coating composition comprises:
an acrylic latex;
1-10% by weight of a glycol ether; and
0.25-5% by weight of humectant,
wherein the coating composition, when measured at 77° F. (25° C.) using a Brookfield HB viscometer equipped with Spindle 3 at 2.5 RPM, has a viscosity ranging from 5000 to 500000cPs,
wherein the air barrier has a water vapor permeance greater than 1 Perm at 35 mil film thickness when measured at 77° F. (23° C.) and 50% RH, according to ASTM E96/E96M-16, Method B.

19. The substrate coated with an air barrier according to claim 18, wherein the coating composition coalesces at an ambient temperature of 20° F. (˜−6.67° C.) or higher.

20. The substrate coated with an air barrier according to claim 18, wherein the substrate is an exterior sheathing panel of a building.
